(19) United States
(12) Patent Application Publication
(10) Pub. No.: US 2001/0054051 A1
(43) Pub. Date: Dec. 20, 2001

(54) Discrete cosine transform system and discrete cosine transform method

(75) Inventor: Junji Tajime, Tokyo (JP)

Correspondence Address: David A. Blumenthal, FOLEY & LARDNER, Washington Harbour, 3000 K Street, N.W., Suite 500, Washington, DC, 20007-5109, US

(73) Assignee: NEC CORPORATION

(21) Appl. No.: 09/870,689

(22) Filed: Jun. 1, 2001

(30) Foreign Application Priority Data
Feb. 6, 2000 (JP) 166135-2000

(51) Int. Cl. G06F 17/14

(52) U.S. Cl. 708/402

(57) ABSTRACT

A discrete cosine transform system and discrete cosine transform method enables speeding up and restricts increasing of system scale size associating with speeding up in a system realizing discrete cosine transform and inverse discrete cosine transform for several kinds of different block sizes. The discrete cosine transform system has one ore more computing modes for performing one of discrete cosine transform and inverse discrete cosine transform for W points (N>W), in addition to a first computing mode for performing one of discrete cosine transform and inverse discrete cosine transform for N points. At least a part of computing units forming the system, may switch computing function in at least part of computing functions for performing discrete cosine transform and inverse discrete cosine transform for points other than N points, for performing the W point discrete cosine transform and inverse discrete cosine transform in parallel by the computing units forming the system.

### BACKGROUND OF THE INVENTION

1. Field of the Invention

The present invention relates generally to a discrete cosine transform system and a discrete cosine transform method. More particularly, the invention relates to a system for realizing discrete cosine transform and inverse discrete cosine transform for a plurality of mutually different block sizes in the discrete cosine transform system to be used for compression of an image or the like.

2. Description of the Related Art

Since an image has large information amount, it is typical to transmit or record the image with compression into a predetermined information amount. Upon receipt or playback, the compressed image is decompressed or expanded into an original information amount.

In general, the image has large amount of low frequency component and small amount of high frequency component. Therefore, if the image is converted into signals of frequency domains, the signals may inclined in the low frequency domain. As a result, by quantizing the signals in low frequency domain with dividing in relatively smaller frequency ranges and by quantizing the signals in the high frequency range with dividing in relatively larger frequency ranges, the image can be compressed with smaller information amount than that before transformation.

One of frequency conversion system to be employed in a moving picture encoding system is discrete cosine transform (DCT) as orthogonal transformation. In the encoding system employing discrete cosine transform, the image is frequently processed per 8×8 pixels. Therefore, 8×8 two-dimensional discrete cosine transform systems and inverse discrete cosine transform systems as inverse transformation have been developed in large number.

However, upon performing transformation of resolution in the frequency domain, or encoding employing discrete cosine transform with different block sizes, a system which can perform discrete cosine transform and inverse discrete cosine transform with a plurality of kinds of mutually different block sizes is required.

Hereinafter, prior art directed to such discrete cosine transform and inverse discrete cosine transform will be discussed. At first, it has been known that two-dimensional discrete cosine transform and two-dimensional inverse discrete cosine transform can be resolved into two times of one-dimensional discrete cosine transform or one-dimensional inverse discrete cosine transform. A system realizing one-dimensional discrete cosine transform and one-dimensional inverse discrete cosine transform becomes important.

Therefore, discussion will be given for the one-dimensional discrete cosine transform and the one-dimensional inverse discrete cosine transform. N point discrete cosine transform for obtaining N in number of outputs X(0) to X(N−1) from N in number of inputs of x(0) to x(N−1) can be expressed by the following formula:

X(k)−√(2/N)·dₖΣₓ(n)cos[(2n+1)kπ/2N](k=0, 1, . . . , N−1)k=0 . . . dₖ=1/√2k≠0 . . . dₖ₌1 (1)

Here, Σ is sum of n=0 to N−1. X(0) to X(N−1) obtained from the foregoing formula (1) are called as DCT coefficient.

In case of N=8, the foregoing formula (1) may be expressed by the following determinant:

$$[ \begin{matrix}X ( 0 ) \\ X ( 1 ) \\ X ( 2 ) \\ X ( 3 ) \\ X ( 4 ) \\ X ( 5 ) \\ X ( 6 ) \\ X ( 7 )\end{matrix} ] = \frac{1}{2} [ \begin{matrix}{c}_{4} & {c}_{4} & {c}_{4} & {c}_{4} & {c}_{4} & {c}_{4} & {c}_{4} & {c}_{4} \\ {c}_{1} & {c}_{3} & {c}_{5} & {c}_{7} & - {c}_{7} & - {c}_{5} & - {c}_{3} & - {c}_{1} \\ {c}_{2} & {c}_{6} & - {c}_{6} & - {c}_{2} & - {c}_{2} & - {c}_{6} & {c}_{6} & {c}_{2} \\ {c}_{3} & - {c}_{7} & - {c}_{1} & - {c}_{5} & {c}_{5} & {c}_{1} & {c}_{7} & - {c}_{3} \\ {c}_{4} & - {c}_{4} & - {c}_{4} & {c}_{4} & {c}_{4} & - {c}_{4} & - {c}_{4} & {c}_{4} \\ {c}_{5} & - {c}_{1} & {c}_{7} & {c}_{3} & - {c}_{3} & - {c}_{7} & {c}_{1} & - {c}_{5} \\ {c}_{6} & - {c}_{2} & {c}_{2} & - {c}_{6} & - {c}_{6} & {c}_{2} & - {c}_{2} & {c}_{6} \\ {c}_{7} & - {c}_{5} & {c}_{3} & - {c}_{1} & {c}_{1} & - {c}_{3} & {c}_{5} & - {c}_{7}\end{matrix} ] [ \begin{matrix}x ( 0 ) \\ x ( 1 ) \\ x ( 2 ) \\ x ( 3 ) \\ x ( 4 ) \\ x ( 5 ) \\ x ( 6 ) \\ x ( 7 )\end{matrix} ] \qquad ( 2 )$$

Here, cₙ=cos(nπ/16).

On the other hand, from the foregoing formula (2), the following formulae (3) and (4) are established:

$$\begin{matrix}[ \begin{matrix}X ( 0 ) \\ X ( 2 ) \\ X ( 4 ) \\ X ( 6 )\end{matrix} ] = \frac{1}{2} [ \begin{matrix}{c}_{4} & {c}_{4} & {c}_{4} & {c}_{4} \\ {c}_{2} & {c}_{6} & - {c}_{6} & - {c}_{2} \\ {c}_{4} & - {c}_{4} & - {c}_{4} & {c}_{4} \\ {c}_{6} & - {c}_{2} & {c}_{2} & - {c}_{6}\end{matrix} ] [ \begin{matrix}x ( 0 ) + x ( 7 ) \\ x ( 1 ) + x ( 6 ) \\ x ( 2 ) + x ( 5 ) \\ x ( 3 ) + x ( 4 )\end{matrix} ] & ( 3 ) \\ [ \begin{matrix}X ( 1 ) \\ X ( 3 ) \\ X ( 5 ) \\ X ( 7 )\end{matrix} ] = \frac{1}{2} [ \begin{matrix}{c}_{1} & {c}_{3} & {c}_{5} & {c}_{7} \\ {c}_{3} & - {c}_{7} & - {c}_{1} & - {c}_{5} \\ {c}_{5} & - {c}_{1} & {c}_{7} & {c}_{3} \\ {c}_{7} & - {c}_{5} & {c}_{3} & - {c}_{1}\end{matrix} ] [ \begin{matrix}x ( 0 ) - x ( 7 ) \\ x ( 1 ) - x ( 6 ) \\ x ( 2 ) - x ( 5 ) \\ x ( 3 ) - x ( 4 )\end{matrix} ] & ( 4 )\end{matrix}$$

On the other hand, N point one-dimensional inverse discrete cosine transform as inverse transformation of N point one-dimensional discrete cosine transform can be expressed as follow:

X(n)=√(2/N)·ΣdₖX(k)cos[(2n+1)kπ/2N](n=0, 1, . . . , N−1) (5)

Here, Σ is a sum of k=0 to N−1.

Similarly. in case of N=8, the foregoing equation (5) is expressed by the following determinant:

$$[ \begin{matrix}X ( 0 ) \\ X ( 1 ) \\ X ( 2 ) \\ X ( 3 ) \\ X ( 4 ) \\ X ( 5 ) \\ X ( 6 ) \\ X ( 7 )\end{matrix} ] = \frac{1}{2} [ \begin{matrix}{c}_{4} & {c}_{1} & {c}_{2} & {c}_{3} & {c}_{4} & {c}_{5} & {c}_{6} & {c}_{7} \\ {c}_{4} & {c}_{3} & {c}_{6} & - {c}_{7} & - {c}_{4} & - {c}_{1} & - {c}_{2} & - {c}_{5} \\ {c}_{4} & {c}_{5} & - {c}_{6} & - {c}_{1} & - {c}_{4} & {c}_{7} & {c}_{2} & {c}_{3} \\ {c}_{4} & {c}_{7} & - {c}_{2} & - {c}_{5} & {c}_{4} & {c}_{3} & - {c}_{6} & - {c}_{1} \\ {c}_{4} & - {c}_{7} & - {c}_{2} & {c}_{5} & {c}_{4} & - {c}_{3} & - {c}_{6} & {c}_{1} \\ {c}_{4} & - {c}_{5} & - {c}_{6} & {c}_{1} & - {c}_{4} & - {c}_{7} & {c}_{2} & - {c}_{3} \\ {c}_{4} & - {c}_{3} & {c}_{6} & {c}_{7} & - {c}_{4} & {c}_{1} & - {c}_{2} & {c}_{5} \\ {c}_{4} & - {c}_{1} & {c}_{2} & - {c}_{3} & {c}_{4} & - {c}_{5} & {c}_{6} & - {c}_{7}\end{matrix} ] [ \begin{matrix}x ( 0 ) \\ x ( 1 ) \\ x ( 2 ) \\ x ( 3 ) \\ x ( 4 ) \\ x ( 5 ) \\ x ( 6 ) \\ x ( 7 )\end{matrix} ] \qquad ( 6 )$$

From the foregoing determinant (6):

$$\begin{matrix}[ \begin{matrix}x ( 0 ) + x ( 7 ) \\ x ( 1 ) + x ( 6 ) \\ x ( 2 ) + x ( 5 ) \\ x ( 3 ) + x ( 4 )\end{matrix} ] = [ \begin{matrix}{c}_{4} & {c}_{2} & {c}_{4} & {c}_{6} \\ {c}_{2} & {c}_{6} & - {c}_{4} & - {c}_{2} \\ {c}_{4} & - {c}_{6} & - {c}_{4} & {c}_{2} \\ {c}_{4} & - {c}_{2} & {c}_{4} & - {c}_{6}\end{matrix} ] [ \begin{matrix}X ( 0 ) \\ X ( 2 ) \\ X ( 4 ) \\ X ( 6 )\end{matrix} ] & ( 7 ) \\ [ \begin{matrix}x ( 0 ) - x ( 7 ) \\ x ( 1 ) - x ( 6 ) \\ x ( 2 ) - x ( 5 ) \\ x ( 3 ) - x ( 4 )\end{matrix} ] = [ \begin{matrix}{c}_{1} & {c}_{3} & {c}_{5} & {c}_{7} \\ {c}_{3} & - {c}_{7} & - {c}_{1} & - {c}_{5} \\ {c}_{5} & - {c}_{1} & {c}_{7} & {c}_{3} \\ {c}_{7} & - {c}_{5} & {c}_{3} & - {c}_{1}\end{matrix} ] [ \begin{matrix}X ( 1 ) \\ X ( 3 ) \\ X ( 5 ) \\ X ( 7 )\end{matrix} ] & ( 8 )\end{matrix}$$

are established.

As one example of the conventional system realizing eight points discrete cosine transform and eight point inverse discrete cosine transform is a discrete cosine transform system disclosed in “A 100 MHz 2-D Discrete Cosine Transform Core Processor” (S. Uramoto et al., IEEE Journal of Solid-State Circuits, Vol. 27, No. 4, pp 492 to 499, April, 1992).

In this system, for performing sum and product operation for matrix operation with the foregoing determinants (3), (4), (7) and (8), in place of large size general purpose adder, memory and adder are used. On the other hand, by inputting eight input signals or eight DCT coefficients in parallel, system capable of further high speed process can be realized.

One example of the system realizing the eight point discrete cosine transform is shown in FIG. 20, and one example of the system realizing eight point inverse discrete cosine transform is shown in FIG. 21. The eight point discrete cosine transform system shown in FIG. 20 is a system applying eight input signals x(0) to x(7) to input terminals I0 to I7 and outputs respective two DCT coefficients [X(0), X(1)], [X(2), X(3)], [X(4), X(5)] and [X(6), X(7)] in order at the output terminals O0 and O1.

It should be noted that, in FIG. 20. the system realizing eight point discrete cosine transform is constructed with adders A12 to A15, adder-subtracters B12 to B18, multipliers C1 to C7, subtracters D6 to D9 and selectors s58 to s64.

In case of the eight point inverse discrete cosine transform in the eight point inverse discrete cosine transform system shown in FIG. 21, DCT coefficients X(0) to X(7) is applied to the input terminals I0 to I7 and then outputs respective two original signals [x(0), x(7)], [x(1), x(6)], [x(2), x(5)], and [x(3), x(4)] at the output terminals O0 and O1, in order.

In FIG. 21, the system realizing eight point inverse discrete cosine transform is constructed with an adder A16, adder-subtracters B0 to B5, multipliers C1 to C7, subtracters D10 and selectors s65 to s70.

In either case of the system shown in FIG. 20 and the system shown in FIG. 21, since only two output signals can be obtained. Therefore, in order to obtain all of eight output signals, the internal selectors have to be switched for four times to perform arithmetic operation for four times.

Next, in case of N=4, using the determinant for the foregoing expression (1), the following expression is established:

$$[ \begin{matrix}X ( 0 ) \\ X ( 1 ) \\ X ( 2 ) \\ X ( 3 )\end{matrix} ] = \frac{1}{\sqrt{2}} [ \begin{matrix}{c}_{4} & {c}_{4} & {c}_{4} & {c}_{4} \\ {c}_{2} & {c}_{6} & - {c}_{6} & - {c}_{2} \\ {c}_{4} & - {c}_{4} & - {c}_{4} & {c}_{4} \\ {c}_{6} & - {c}_{2} & {c}_{2} & - {c}_{6}\end{matrix} ] [ \begin{matrix}X ( 0 ) \\ X ( 1 ) \\ X ( 2 ) \\ X ( 3 )\end{matrix} ] \qquad ( 9 )$$

Similarly, in case of N=4, using the determinant for the foregoing expression (5), the following expression is established:

$$[ \begin{matrix}X ( 0 ) \\ X ( 1 ) \\ X ( 2 ) \\ X ( 3 )\end{matrix} ] = \frac{1}{\sqrt{2}} [ \begin{matrix}{c}_{4} & {c}_{2} & {c}_{4} & {c}_{6} \\ {c}_{4} & {c}_{6} & - {c}_{4} & - {c}_{2} \\ {c}_{4} & - {c}_{6} & - {c}_{4} & {c}_{2} \\ {c}_{4} & - {c}_{2} & {c}_{4} & - {c}_{6}\end{matrix} ] [ \begin{matrix}X ( 0 ) \\ X ( 1 ) \\ X ( 2 ) \\ X ( 3 )\end{matrix} ] \qquad ( 10 )$$

The foregoing determinants (9) and (10) are similar to the determinants (3) and (4).

When N is powers of 2, N point discrete cosine transform and N point inverse discrete cosine transform are frequently calculated using determinants of N/2ⁿ point discrete cosine transform and N/2ⁿ point inverse discrete cosine transform for simplification. In this case, N/2ⁿ discrete cosine transform and N/2ⁿ inverse discrete cosine transform can be calculated with the same system. Here, n is a positive number satisfying 2ⁿ≦N.

Next, consideration is given for the case of the resolution transformation in the frequency domain. As a resolution transformation system in the frequency domain, for example, for the DCT coefficients X(0), . . . , X(3) derived by eight point discrete cosine transform, there is a system for performing four point inverse discrete cosine transform.

When this system is employed, as expressed in the following expression,

X(n)=[1/√(2)]·Σdₖ[1/√(2)]X(k)·cos[(2n+1)kπ/8](n=0, 1, . . . , N−1) (11)

it becomes necessary to multiply the DCT coefficients X(k) for 1/√2 times, for matching the DCT coefficient of eight point discrete cosine transform in the range of the DCT coefficient of the four point discrete cosine transform. Here, Σ is a sum of k=0 to 3.

In this case, employing the determinant for the foregoing expression (11), the following determinant is expressed:

$$[ \begin{matrix}X ( 0 ) \\ X ( 1 ) \\ X ( 2 ) \\ X ( 3 )\end{matrix} ] = \frac{1}{2} [ \begin{matrix}{c}_{4} & {c}_{2} & {c}_{4} & {c}_{6} \\ {c}_{4} & {c}_{6} & - {c}_{4} & - {c}_{2} \\ {c}_{4} & - {c}_{6} & - {c}_{4} & {c}_{2} \\ {c}_{4} & - {c}_{2} & {c}_{4} & - {c}_{6}\end{matrix} ] [ \begin{matrix}X ( 0 ) \\ X ( 1 ) \\ X ( 2 ) \\ X ( 3 )\end{matrix} ] \qquad ( 12 )$$

The foregoing determinant (12) is similar to the determinant (7). Therefore, it can be calculated with the same system.

In the foregoing conventional system, by providing slight modification for the N point discrete cosine transform system and N point inverse discrete cosine transform system, it becomes possible to perform N/2ⁿ point discrete cosine transform and N/2ⁿ point inverse discrete cosine transform. A problem is encountered to require a period corresponding to that required for N point discrete cosine transform and N point inverse discrete cosine transform.

For example, even in either case of the system shown in FIG. 20 and the system shown in FIG. 21, since only two output signals can be obtained. Therefore, in order to obtain all of eight output signals, the internal selectors have to be switched for four times to perform arithmetic operation for four times.

It can be considered to newly add the arithmetic circuit and to operate the arithmetic circuits in parallel for realizing high speed process. However, in such case, another program of increasing of the scale of the system is inherently encountered.

### SUMMARY OF THE INVENTION

The present invention has been worked out for solving the problem set forth above. It is therefore an object of the present invention to provide a discrete cosine transform system and discrete cosine transform method thereof, which enables speeding up and restricts increasing of system scale size associating with speeding up in a system realizing discrete cosine transform and inverse discrete cosine transform for several kinds of different block sizes.

According to the first aspect of the invention, a discrete cosine transform system having one or more computing modes for performing one of discrete cosine transform and inverse discrete cosine transform for W points which W is positive integer satisfying N>W, in addition to a first computing mode for performing one of discrete cosine transform and inverse discrete cosine transform for N points which N is positive integer, comprises:

means provided at least a part of computing units forming the system, for switching computing function in at least part of computing functions for performing discrete cosine transform and inverse discrete cosine transform for points other than N points, for performing the W point discrete cosine transform and inverse discrete cosine transform in parallel by the computing units forming the system.

N may be powers of 2 (2ⁿ), and the W points is N/2ⁿ (n is a positive integer satisfying 2ⁿ≦N). The discrete cosine transform system may further have computing modes for performing one of N point discrete cosine transform and N point inverse discrete cosine transform as partial computation of one of K point discrete cosine transform and K point inverse discrete cosine transform, which K point is greater than N point, and for performing partial computation of one of discrete cosine transform and inverse discrete cosine transform for other than N points, and

the system comprises storage means for storing results of computation; and

computing means for performing partial computation of one of the K point discrete cosine transform and K point inverse discrete cosine transform using the result of computation and a storage value of the storage means. N points and K points may be powers of 2 (2ⁿ). The discrete cosine transform system may have a plurality of systems each having computing mode for performing one of N point discrete cosine transform and N point inverse discrete cosine transform, computing modes for performing one of W point discrete cosine transform and W point inverse discrete cosine transform, which W is smaller than N, and computing mode for performing partial computation of one of K point discrete cosine transform and K point inverse discrete cosine transform which K is greater than N, the systems are adapted for parallel operation, and the discrete cosine transform system includes computing means for performing partial computation one of K point discrete cosine transform and K point inverse discrete cosine transform. N points and K points may be powers of 2 and W points may be N/2ⁿ (n is a positive integer satisfying 2ⁿ≦N).

According to the second aspect of the present invention, discrete cosine transform method having one ore more computing modes for performing one of discrete cosine transform and inverse discrete cosine transform for W points which W is positive integer satisfying N>W, in addition to a first computing mode for performing one of discrete cosine transform and inverse discrete cosine transform for N points which N is positive integer, comprises:

switching computing function in at least part of computing functions for performing discrete cosine transform and inverse discrete cosine transform for points other than N points, for performing the W point discrete cosine transform and inverse discrete cosine transform in parallel by the computing units forming the system.

The discrete cosine transform method may further have computing modes for performing one of N point discrete cosine transform and N point inverse discrete cosine transform as partial computation of one of K point discrete cosine transform and K point inverse discrete cosine transform, which K point is greater than N point, and for performing partial computation of one of discrete cosine transform and inverse discrete cosine transform for other than N points, and

comprising steps of

storing results of computation; and

performing partial computation of one of the K point discrete cosine transform and K point inverse discrete cosine transform using the result of computation and a storage value of the storage means. The discrete cosine transform method performs computing mode for performing one of N point discrete cosine transform and N point inverse discrete cosine transform, computing modes for performing one of W point discrete cosine transform and W point inverse discrete cosine transform, which W is smaller than N, and computing mode for performing partial computation of one of K point discrete cosine transform and K point inverse discrete cosine transform which K is greater than N in parallel operation, and the discrete cosine transform system includes computing means for performing partial computation one of K point discrete cosine transform and K point inverse discrete cosine transform.

According to the third aspect of the invention, a discrete cosine transform system comprises:

input selecting portion determining a destination for supplying input DCT coefficient;

N/2ⁿ point inverse discrete cosine transform performing N/2ⁿ point inverse discrete cosine transform for DCT coefficients input from the input selecting portion;

dual mode selective computing portion performing partial computation of N point inverse discrete cosine transform or N/2ⁿ point inverse discrete cosine transform doe DCT coefficients input from the input selecting portion; and

N point inverse discrete cosine transform partial computing portion for performing partial computation of N point inverse discrete cosine transform or multiplication of coefficients from the result of computation supplied from the N/2ⁿ point inverse discrete cosine transform portion and the result of computation supplied from the dual mode selective computing portion.

The duel mode selective computing portion is replaced with M mode selective computing portion for selection among three or more modes. A plurality of the M mode selective computing circuit for parallel operation.

According to the fourth aspect of the invention, a discrete cosine transform system comprises:

N point inverse discrete cosine transform portion performing either N point inverse discrete cosine transform or partial computation of K (K>N) point inverse discrete cosine transform;

storage portion storing result of computation of N point inverse discrete cosine transform in the N point inverse discrete cosine transform portion; and

K point inverse discrete cosine transform partial computing portion performing partial computation of K point inverse discrete cosine transform using the result of computation supplied from the storage portion and a result of computation of K point inverse discrete cosine transform partial computation supplied from the N point inverse discrete cosine transform portion.

According to the fifth aspect of the present invention, a discrete cosine transform system comprises:

a plurality of N point inverse discrete cosine transform portions operable in parallel and performing computation by switching computing function to partial computation of K point (K>N) inverse discrete cosine transform;

K point inverse discrete cosine transform partial computing of K point inverse discrete cosine transform using the result of partial computation of K point inverse discrete cosine transform supplied from the plurality of N point inverse discrete cosine transform portions.

In the operation, the conventional eight point inverse discrete cosine transform system takes eight DCT coefficients X(0) to X(7) to output every two original signals [X(0), X(7)], [X(1),X(6) , X(2),X(5)] and [X(3),X(4)] in sequential order. As a result, for performing eight point inverse discrete cosine transform, four times of operation becomes necessary.

Here, in the eight point inverse discrete cosine transform system, the butterfly operation is performed by the butterfly operation portion at the end of the process. However, since computing for x(0) to x(3) is performed in four point inverse discrete cosine transform portion, computation for x(4) to x(7) is performed in the eight point inverse discrete cosine transform portion.

Consideration is given for four point inverse discrete cosine transform by the eight point inverse discrete cosine transform system . The four point inverse discrete cosine transform is included in the eight point inverse discrete cosine transform. Then, as the output of the four point inverse discrete cosine transform, the output of the four point inverse discrete cosine transform portion is output directly. In this case, the output timing is to every one outputs in order to x(0), x(1), x(2) and (3) in sequential order. As a result, when four point inverse discrete cosine transform is performed by using the eight point inverse discrete cosine transform system, the same number of times of computation as the eight point inverse discrete cosine transform

Next, consideration is given for the case where even in the four point inverse discrete cosine transform, every two original signals are output at every computation. As the simplest method to realize is to add a four point inverse discrete cosine transform portion. However, in this case, the scale of the system is inherently increased.

In the eight point inverse discrete cosine transform system according to the present invention, two computing functions of partial computing (computing mode 1) of the eight point inverse discrete cosine transform and four point inverse discrete cosine transform (computing mode 2) are provided for the eight point inverse discrete cosine transform partial computing portion.

When two computing modes are employed. In the computing mode 1, the eight point inverse discrete cosine transform performed. In the computing mode 2, the computing function of the eight point inverse discrete cosine transform partial computing portion is switched into the function of the four point inverse discrete cosine transform portion to perform four portion inverse discrete cosine transform in parallel.

As set forth above, in the shown embodiment, a plurality of computing functions are switched for realizing parallel operation to obtain the desired output with half of the typical processing period. On the other hand, since the computing unit of the eight point inverse discrete cosine transform partial computing portion 82 are used in common, which are not operated when four point inverse discrete cosine transform is performed in the four point inverse discrete cosine transform portion. Therefor, in comparison with the case where the four point inverse discrete cosine transform unit is added, the system with simpler construction can be realized.

Accordingly, it becomes possible to realize the system which can perform discrete cosine transform and inverse discrete cosine transform for a plurality of different block sizes. Concerning processes for small block size, high speed process and simplification of system construction are realized by operating the computing units in parallel.

### BRIEF DESCRIPTION OF THE DRAWINGS

The present invention will be understood more fully from the detailed description given hereinafter and from the accompanying drawings of the preferred embodiment of the present invention, which, however, should not be taken to be limitative to the invention, but are for explanation and understanding only.

In the drawings:

FIG. 1 is a block diagram showing a construction of the first embodiment of an eight point inverse discrete cosine transform system according to the present invention;

FIG. 2 is a block diagram showing a construction of the first embodiment of an eight point inverse discrete cosine transform system according to the present invention;

FIG. 3 is a block diagram showing an example of a construction of a dual mode selective computing unit T1 of FIG. 2;

FIG. 4 is a block diagram showing an example of a construction of a dual mode selective computing unit T2 of FIG. 2;

FIG. 5 is a block diagram showing an example of a construction of a dual mode selective computing unit T3 of FIG. 2;

FIG. 6 is a block diagram showing a construction of the second embodiment of the inverse discrete cosine transform system according to the present invention;

FIG. 7 is a block diagram showing a construction of the second embodiment of the eight point inverse discrete cosine transform system according to the present invention;

FIG. 8 is a block diagram showing a construction of the third embodiment of the inverse discrete cosine transform system according to the present invention;

FIG. 9 is a block diagram showing a construction of the third embodiment of the eight point inverse discrete cosine transform system according to the present invention;

FIG. 10 is a block diagram showing an example of a construction of a dual mode selective computing unit T4 of FIG. 9;

FIG. 11 is a block diagram showing a construction of the fourth embodiment of the inverse discrete cosine transform system according to the present invention;

FIG. 12 is a block diagram showing a construction of the fourth embodiment of the four point inverse discrete cosine transform system according to the present invention;

FIG. 13 is a block diagram showing a construction of the fifth embodiment of the inverse discrete cosine transform system according to the present invention;

FIG. 14 is a block diagram showing a construction of the fifth embodiment of the inverse discrete cosine transform system according to the present invention;

FIG. 15 is an illustration for explaining the effect of the present invention;

FIG. 16 is an illustration for explaining the effect of the present invention;

FIG. 17 is an illustration for explaining the effect of the present invention;

FIG. 18 is an illustration for explaining the effect of the present invention;

FIGS. 19A to 19C are illustrations for explaining the effect of the present invention;

FIG. 20 is a block diagram showing a construction of the conventional eight point discrete cosine transform system; and

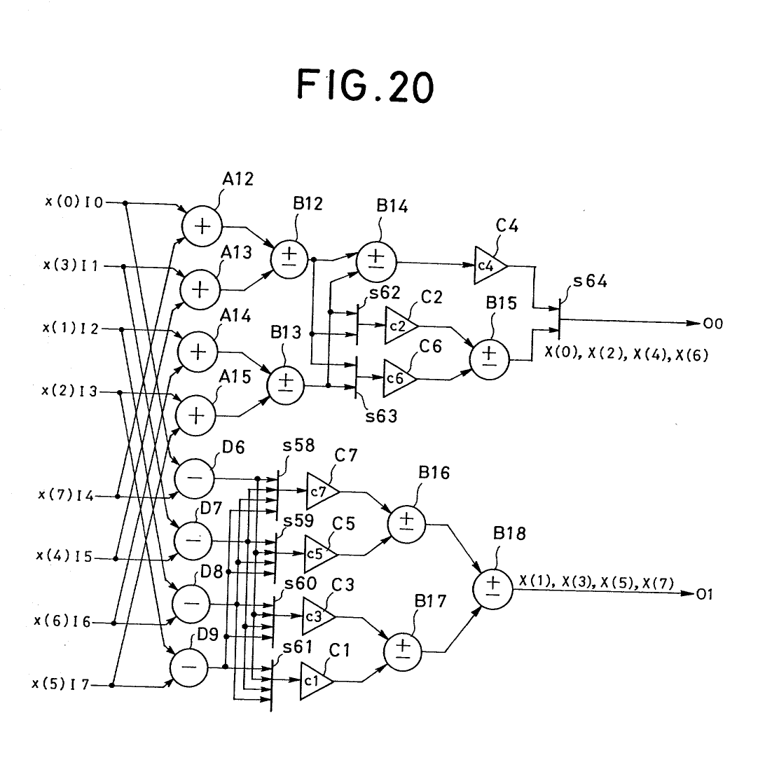

FIG. 21 is a block diagram showing a construction of the conventional eight point inverse discrete cosine transform system.

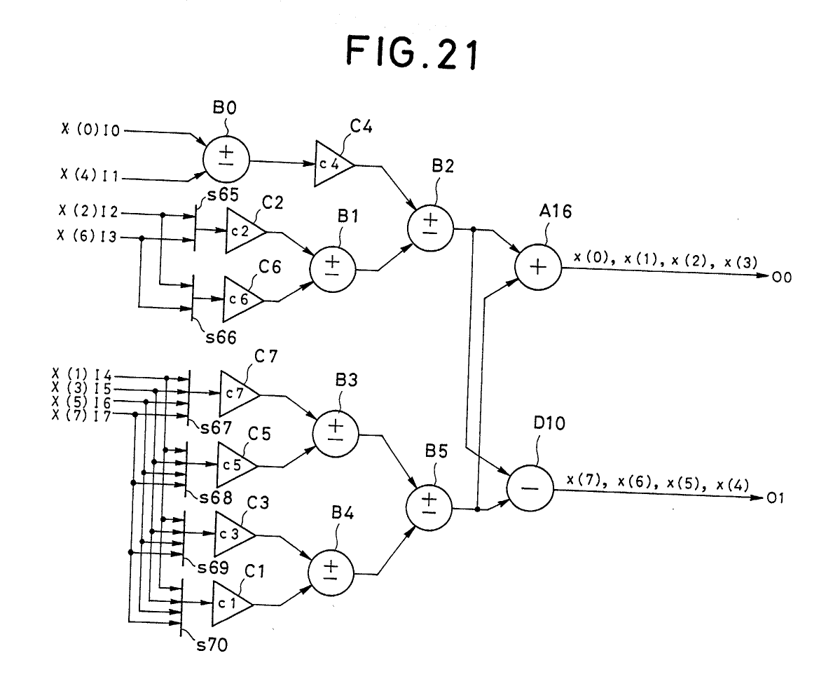

### DESCRIPTION OF THE PREFERRED EMBODIMENT

The present invention will be discussed hereinafter in detail in terms of the preferred embodiment of the present invention with reference to the accompanying drawings. In the following description, numerous specific details are set forth in order to provide a thorough understanding of the present invention. It will be obvious, however, to those skilled in the art that the present invention may be practiced without these specific details. In other instance, well-known structure are not shown in detail in order to avoid unnecessary obscurity of the present invention.

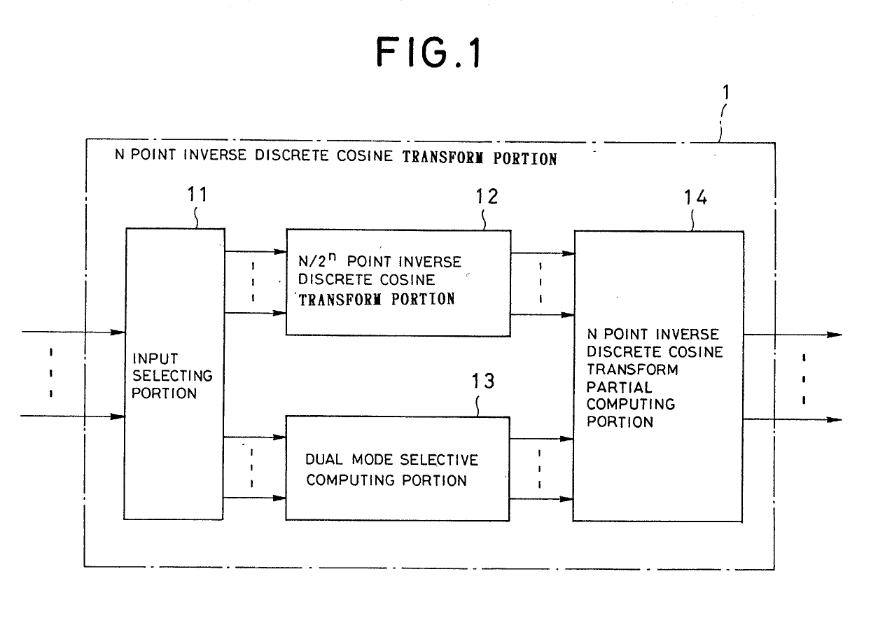

FIG. 1 is a block diagram showing a construction of the first embodiment of the inverse discrete cosine transform system according to the present invention. In FIG. 1, the first embodiment of an inverse discrete cosine transform system is constructed with a N point inverse discrete cosine transform portion 1. It should be noted that, in the first embodiment of the present invention, the inverse discrete cosine transform is employed as system construction. However, the shown embodiment can be implemented even with a discrete cosine transform system or a system which has a function for performing both of discrete cosine transform and inverse discrete cosine transform. In the following disclosure, N is powers of 2 (2², 2³, . . . ).

The N point inverse discrete cosine transform portion 1 is constructed with an input selecting portion 11, an N/2ⁿ inverse discrete cosine transform portion 12, a dual mode selective computing unit 13 and a N point inverse discrete cosine transform partial computing portion 14. On the other hand, the N point inverse discrete cosine transform portion 1 has two computing modes. In a first computing mode, a N point inverse discrete cosine transform is performed, and in a second computing mode, a N/2ⁿ point inverse discrete cosine transform is performed.

At first, in the first computing mode, N in number of DCT coefficients are supplied to the input selecting portion 11 as input. In the input selecting portion 11, supply destination of the supplied N DCT coefficients is determined to supply to the N/2ⁿ point inverse discrete cosine transform portion 12 and the dual mode selective computing unit 13.

In the N/2ⁿ point inverse discrete cosine transform portion 12, for the DCT coefficient supplied from the input selecting portion 11, N/2ⁿ point inverse discrete cosine transform is performed to supply a result to the N point inverse discrete cosine transform partial computing portion 14.

In the dual mode selective computing unit 13, when the computing mode is the first computing mode, the computing unit is switched for performing partial computation of the N point inverse discrete cosine transform to perform partial computation of the N point inverse discrete cosine transform for the DCT coefficient supplied from the input selecting portion 11, to supply result of computation to the N point inverse discrete cosine transform partial computing portion 14.

In the N point inverse discrete cosine transform partial computing portion 14, partial computation is performed using the result of computation supplied from the N/2ⁿ inverse discrete cosine transform portion 12 and a result of computation supplied from the dual mode selective computing unit 13 to output a result of computation of the N point inverse discrete cosine transform.

Next, in the second mode, N/2ⁿ in number of DCT coefficients are supplied to the input selecting portion 11 as inputs. In the input selecting portion 11, supply destination of N/2ⁿ DCT coefficients is determined to supply to the N/2ⁿ point inverse discrete cosine transform portion 12 and the dual mode selective computing unit 13.

In the N/2ⁿ point inverse discrete cosine transform portion 12, for the DCT coefficient supplied from the input selecting portion 11, N/2ⁿ point inverse discrete cosine transform is performed to supply a result to the N point inverse discrete cosine transform partial computing portion 14.

In the dual mode selective computing unit 13, when the computing mode is the second computing mode, the computing unit is switched for performing the N/2ⁿ point inverse discrete cosine transform to perform the N/2ⁿ point inverse discrete cosine transform for the DCT coefficient supplied from the input selecting portion 11, to supply result of computation to the N point inverse discrete cosine transform partial computing portion 14.

In the N point inverse discrete cosine transform partial computing portion 14, for the result of computation supplied from the N/2ⁿ inverse discrete cosine transform portion 12 and a result of computation supplied from the dual mode selective computing unit 13, multiplication of the coefficient or supplied value is directly output.

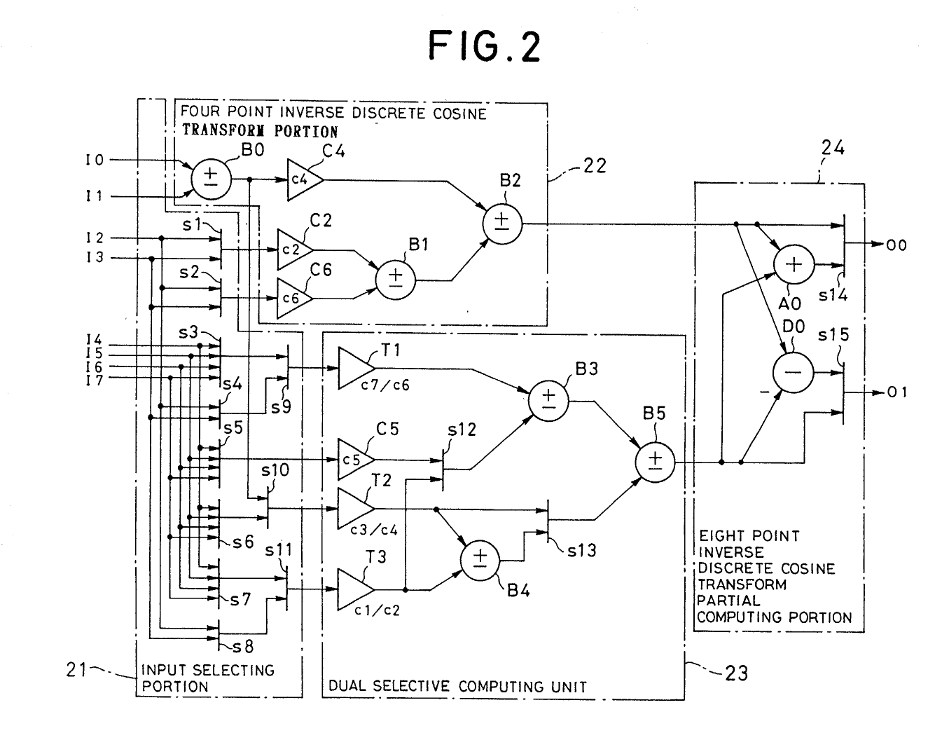

FIG. 2 is a block diagram showing a construction of the first embodiment of an eight point inverse discrete cosine transform system according to the present invention. In FIG. 2, the first embodiment of the 8 point inverse discrete cosine transform system are constructed with an input selecting portion 21, a four point inverse discrete cosine transform portion 22, a dual mode selective computing unit 23 and an eight point inverse discrete cosine transform partial computing portion 24.

The input selecting portion 21 is constructed with selectors s1 to s11. The four point inverse discrete cosine transform portion 22 is constructed with adder-subtracters B0 to B2 and multipliers C2, C4 and C6. The duel mode selective computing portion 23 is constructed with adder-subtracters B3 to B5, a multiplier C5, dual mode selective computing units T1 to T3 and selectors s12 and s13. The 8 point inverse discrete cosine transform partial computing portion 24 is constructed with an adder A0, a subtracter D0 and selectors s14 and s15.

The shown embodiment has two computing modes to perform eight point inverse discrete cosine transform in the first computing mode and four point inverse discrete cosine transform in the second computing mode. At first, in the first computing mode, eight DCT coefficients are supplied to input terminals I0 to I7 as inputs. The input terminals I0 to I7 supplies the DCT coefficient to the input selecting portion 21.

In the input selecting portion 21, for eight DCT coefficients supplied, the DCT coefficients at the input terminals I0 to I3 are supplied to the four point inverse discrete cosine transform portion 22, the DCT coefficients at the input terminals I2 to I7 are supplied to the dual mode selective computing portion 23. The input terminals I2 to I7 are selectively supplied by selectors s3 to s11. In case of the first computing mode, the input terminals I4 to I7 are selected.

In the four point inverse discrete cosine transform portion 22, for the DCT coefficient supplied from the input selecting portion 21, matrix operation used in the foregoing formula (7) is performed to supply the result of computation to the eight point inverse discrete cosine transform partial computing portion 24.

In the dual mode selective computing portion 23, if the computing mode is the first computing mode, dual mode selective computing units T1, T2 and T3 are switched the multipliers to c7, c3 and c1, respectively. On the other hand, the selector is switched to select the result of computation of the first computation mode.

Next, in the dual mode selective computing portion 23, for the DCT coefficient supplied from the input selecting portion 21, matrix operation used in the foregoing formula (8) is performed to supply the result of computation to the eight point inverse discrete cosine transform partial computing portion 24.

In the eight point inverse discrete cosine transform partial computing portion 24, a butterfly operation is performed using the result of computation supplied from the four point inverse discrete cosine transform portion 22 and the result of computation supplied from the dual mode selective computing portion 23 to output the result of computation of the eight point inverse discrete cosine transform to the output terminals O0 and O1. Here, it is required to make the result of the butterfly operation into half. However, in the shown embodiment, the process for making the result of butterfly operation into half is eliminated.

In the second operation mode, four DCT coefficients are supplied as inputs to the input terminals I0 to I3. The input terminals I0 to I3 supply the DCT coefficients to the input selecting portion 21. In the input selecting portion 21, for four DCT coefficients supplied, the DCT coefficients of the input terminals I0 to I3 is supplied to the four inverse discrete cosine transform portion 22. The DCT coefficient of the input terminals I2 and I3 and the result of computation supplied to the input selecting portion 21 from the four inverse discrete cosine transform portion 22 is supplied to the two mode selective computing portion 23.

In the four point inverse discrete cosine transform portion 22, similarly to the first computing mode, matrix operation is performed. The result of computation is supplied to the eight point inverse discrete cosine transform partial computing portion 24. In the dual mode selective computing portion 23, when computing mode is the second computing mode, the multipliers of the dual mode selective computing units T1, T2 and T3 are switched to c6, c4 and c2, respectively. On the other hand, the selector switches to select the result of computation in the second computing mode.

In this case, the dual mode selective computing portion 23 becomes equivalent functional component as the four point inverse discrete cosine transform portion 22 to perform matrix operation using the formula (7) for supplying the result of computation to the eight point inverse discrete cosine transform partial computing portion 24.

In the eight point inverse discrete cosine transform partial computing portion 24, in case of the second computing mode, the results of computation supplied from the four point inverse discrete cosine transform portion 22 and the dual mode selective computing portion 23 are supplied to the output terminals O0 and O1 as results of computing of the four point inverse discrete cosine transform.

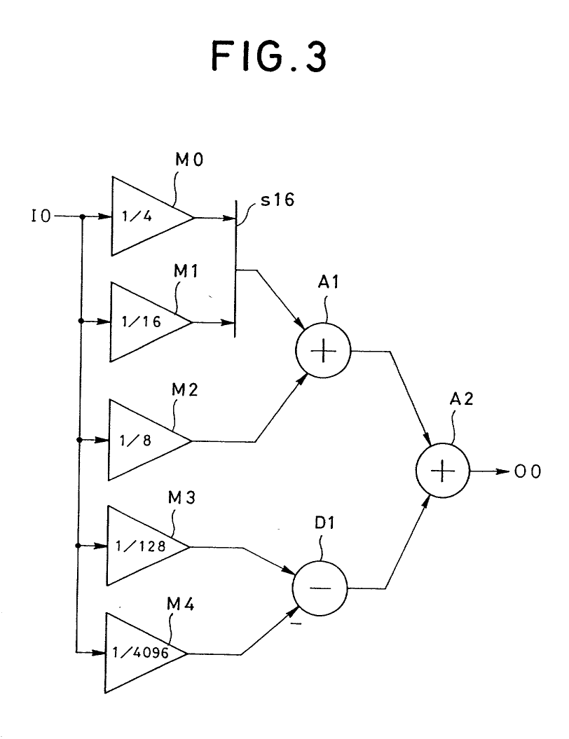

FIG. 3 is a block diagram showing an example of construction of the dual mode selective computing unit T1 of FIG. 2. In FIG. 3, the dual mode selective computing unit T1 is constructed with adders A1 and A2, the subtracter D1, the multipliers M0 to M4, and a selector s16.

The dual mode selective computing unit T1 shows the case where c6=cos (6π/16) and c7=cos (7π/16) are approximated at 12 bits after decimal point. In this case, c6 and c7 are expressed as follows:

$$\begin{matrix}\begin{matrix}c6 = cos ( 6 π / 16 ) \\ = 0.011000011111 \\ = 1 / 4 + 1 / 8 + 1 / 128 - 1 / 4096\end{matrix} & ( 13 ) \\ \begin{matrix}c7 = cos ( 7 π / 16 ) \\ = 0.01100011111 \\ = 1 / 8 + 1 / 16 + 1 / 128 - 1 / 4096\end{matrix} & ( 14 )\end{matrix}$$

Here, difference of operation of c6 and c7 is that the inputs to the adders A1 and A2 is ¼ or 1/16. At the input of the adder A1 of the dual mode selective computing unit T1, the selector selecting the results of computation of the ¼ computing unit and the 1/16 multiplier is provided. By switching the selector, multiplication of the input and c6 or multiplication of the input and c7 can be realized.

Operation of the multipliers M0 to M4 is multiplication of ½ⁿ (n is positive number), process corresponding to right bit shift is performed. As compared with the fixed multiplier, the dual mode selective computing unit T1 merely increases selector. Therefore, scale of the system is not significantly varied from the fixed multiplier C6.

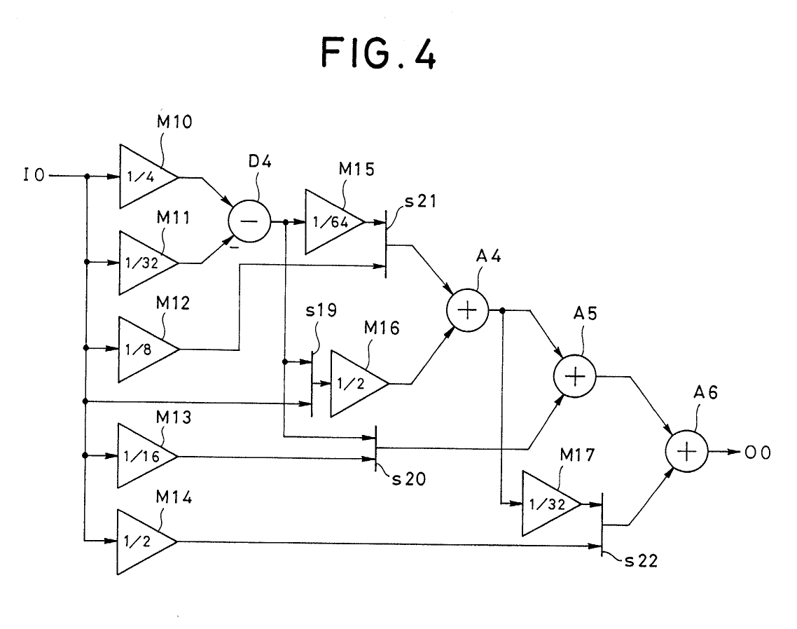

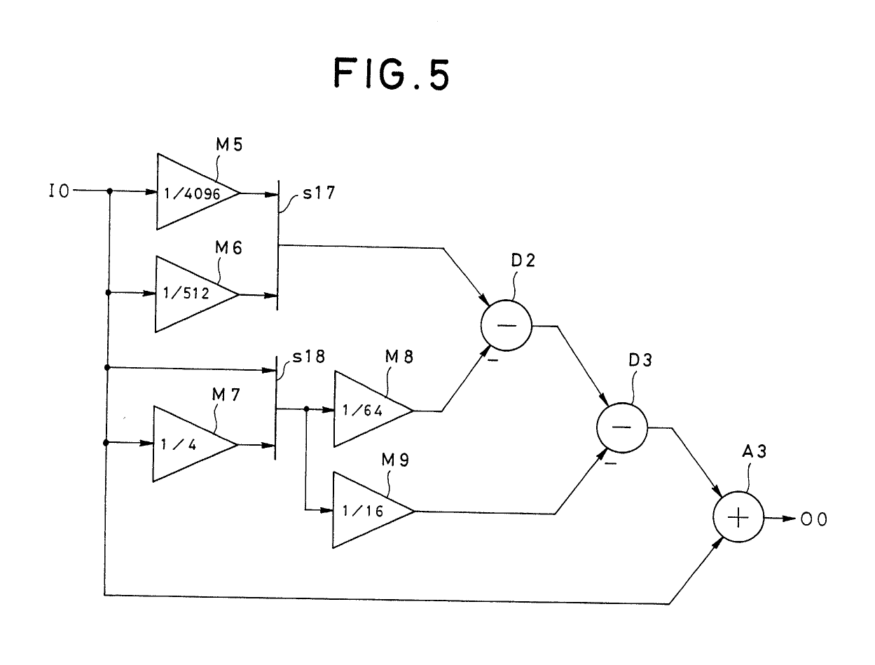

FIG. 4 is a block diagram showing an example of a construction of a dual mode selective computing unit T2 of FIG. 2, and FIG. 5 is a block diagram showing an example of a construction of a dual mode selective computing unit T3 of FIG. 2. In these FIGS. 4 and 5, the dual mode selective computing unit T2 is constructed with adders A4 to A6, a subtracter D4, the multipliers M10 to M17 and selectors s19 to s22. On the other hand, the dual mode selective computing unit T3 is constructed with an adder A3, subtracters D2 and D3. multipliers M5 to M9 and selectors s17 and s18.

It should be noted that the foregoing constructions of the dual mode selective computing units T1 to T3 are mere examples and various other constructions may be taken for forming the dual mode selective computing unit. Also, in the dual mode selective computing units T1 to T3, various combinations as operational function may be considered.

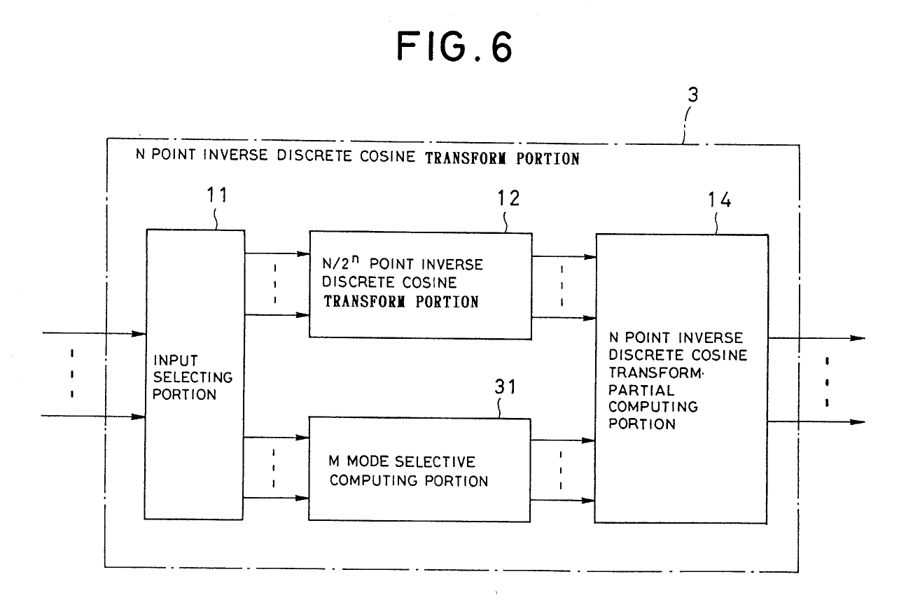

FIG. 6 is a block diagram showing a construction of the second embodiment of the inverse discrete cosine transform system according to the present invention. In FIG. 6, in the first embodiment of the inverse discrete cosine transform system, the dual mode selective computing unit 13 having two operation modes is provided to perform operation with switching the operational functions depending upon the computing mode. In contrast to this, the second embodiment of the inverse discrete cosine transform according to the present invention is provided with M mode selective computing portion 31 having M kinds of computing modes in the N point inverse discrete cosine transform portion 3.

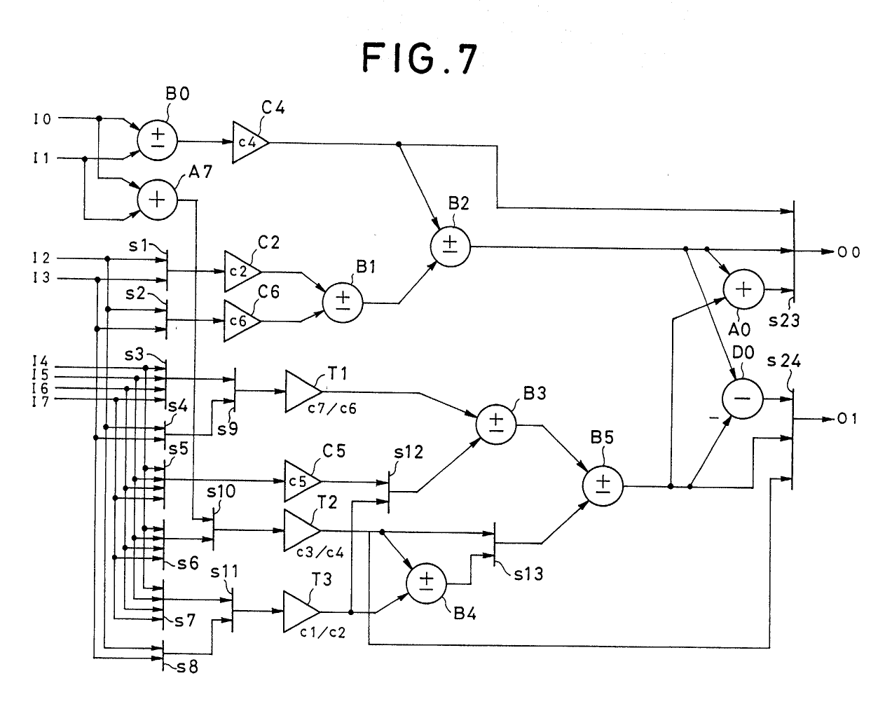

FIG. 7 is a block diagram showing a construction of the second embodiment of the eight point inverse discrete cosine transform system according to the present invention. In FIG. 7, the second embodiment of the eight point inverse discrete cosine transform system has three computing modes. The second embodiment is differentiated from the first embodiment of the eight point inverse discrete cosine transform system in that, in the first computing mode, eight point inverse discrete cosine transform is performed, in the second computing mode, four point inverse discrete cosine transform is performed, and in the third computing mode, two point inverse discrete cosine transform is performed.

The second embodiment of the eight point inverse discrete cosine transform system according to the present invention is constructed with adders A0 and A7, adder-subtracters B0 to B5, multipliers C2 and C4 to C6, a subtracter D0, dual mode selective computing units T1 to T3 and selectors s1 to s13, s23 and s24.

Hereinafter, discussion will be given only for the third mode, in which operation is differentiated from the first embodiment of the eight point inverse discrete cosine transform system according to the present invention. The two point inverse discrete cosine transform can be realized by addition and subtraction of two DCT coefficients and multiplication of c4.

In the third computing mode, the multiplier of the dual mode selective computing unit T2 is switched to c4. Two DCT coefficients are input to the input terminals I0 and I1 as inputs and the input terminals I0 and I1 supply the DCT coefficient to the adder-subtracter B0 and the adder A7.

In the adder-subtracter B0, subtraction of the input value is performed to supply the result of computation to the multiplier C4. In the adder A7, addition of the input value is performed to supply the result of computation to the dual mode selective computing unit T2. The multiplier C4 and the dual mode selective computing unit T2 performs multiplication of the supplied result of computation and c4 to output to the output terminals O0 and O1 as the result of computation of the two point inverse discrete cosine transform.

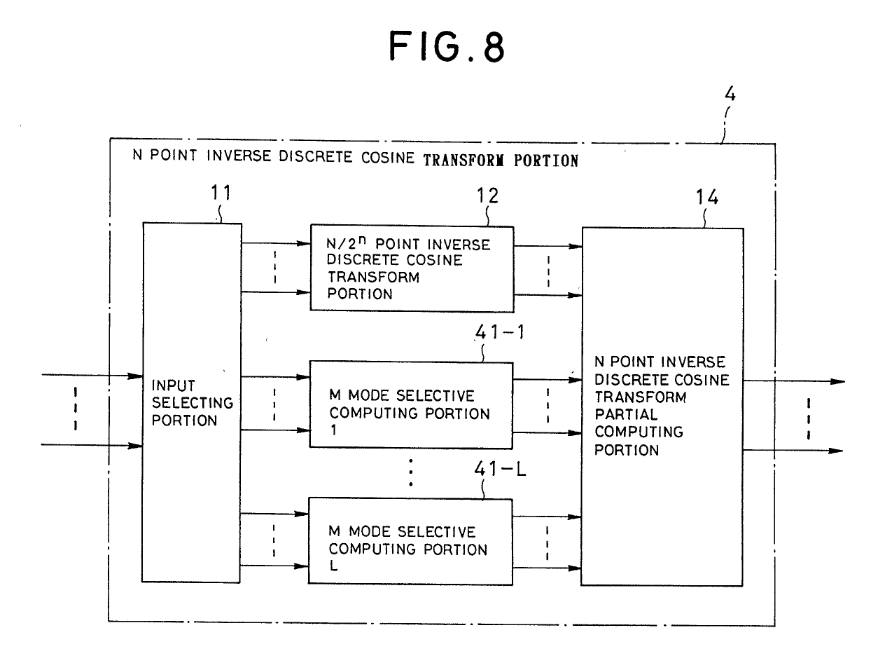

FIG. 8 is a block diagram showing a construction of the third embodiment of the inverse discrete cosine transform system according to the present invention. In the foregoing second embodiment of inverse discrete cosine transform of the present invention, when computing mode other than N point inverse discrete cosine transform is selected, N/2ⁿ point inverse discrete cosine transform is performed in two parallel operation by switching the M mode selective computing unit 31 into N/2ⁿ point inverse discrete cosine transform, the third embodiment of the inverse discrete cosine transform system according to the present invention has L in number of M mode selective computing unit [(1) to (L)] 41-1 to 41-L in the N point inverse discrete cosine transform portion 4 to perform L parallel operation.

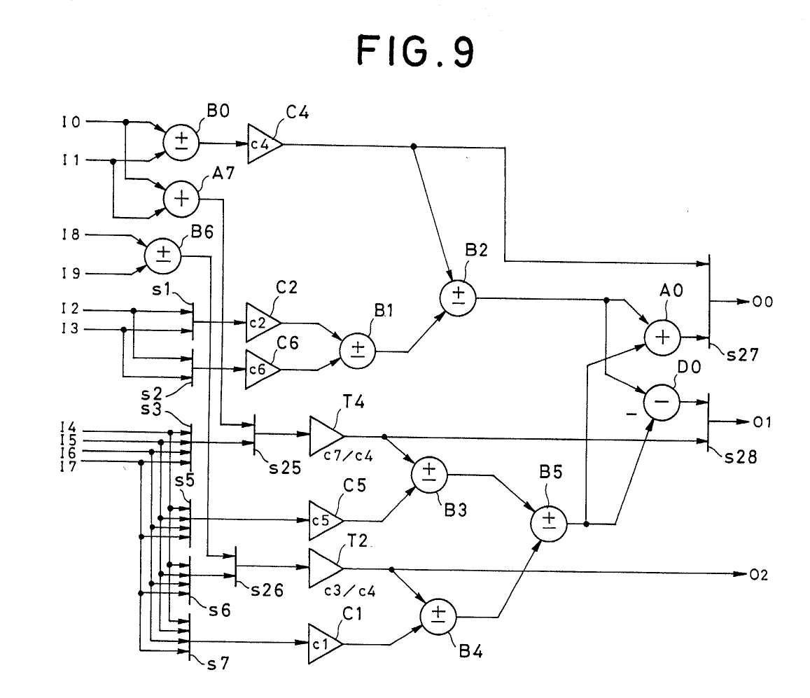

FIG. 9 is a block diagram showing a construction of the third embodiment of the eight point inverse discrete cosine transform system according to the present invention. In FIG. 9, the third embodiment of the eight point inverse discrete cosine transform system according to the present invention has two computing modes, the eight point inverse discrete cosine transform is performed in the first computing mode, and two point inverse discrete cosine transform is performed in the second computing mode. On the other hand, in the shown embodiment, the second computing mode is performed in three parallel operation.

The third embodiment of the eight point inverse discrete cosine transform system according to the present invention is constructed with adders A0 and A7, adder-subtracters B0 to B6, multipliers C1, C2 and C4 to C6, the subtracter D0, the dual mode selective computing units T2 and T4 and selectors s1 to s3, s5 to s7 and s25 to s28.

Hereinafter, discussion will be given only for the second computing mode, in which operation is different from the first embodiment of the present invention in FIG. 2. In the second computing mode, the multiplier of the dual mode selective computing units T2 and T4 is switched to c4.

Four DCT coefficient is supplied to the input terminals I0, I1, I8 and I9 as input. The input terminals I0 and I1 supply the DCT coefficient to the adder-subtracter B0 and the adder A7. The input terminals I8 and I9 supply the DCT coefficient to the adder-subtracter B6.

In the adder-subtracter B0, subtraction of the supplied DCT coefficient is performed to supply the result of computing to the multiplier C4. In the adder A7, addition of the supplied DCT coefficient is performed to supply the result of computing to the dual mode selective computing unit T4.

In the adder-subtracter B6, addition and subtraction of the supplied DCT coefficient is performed to supply the result of computing to the dual mode selective computing unit T2. The multiplier C4, the dual mode selective computing unit T2 and the dual mode selective computing unit T4 performs multiplication of the result of computation and c4 to output to the output terminals O0, O1 and O2 as the result of computing of the two point inverse discrete cosine transform.

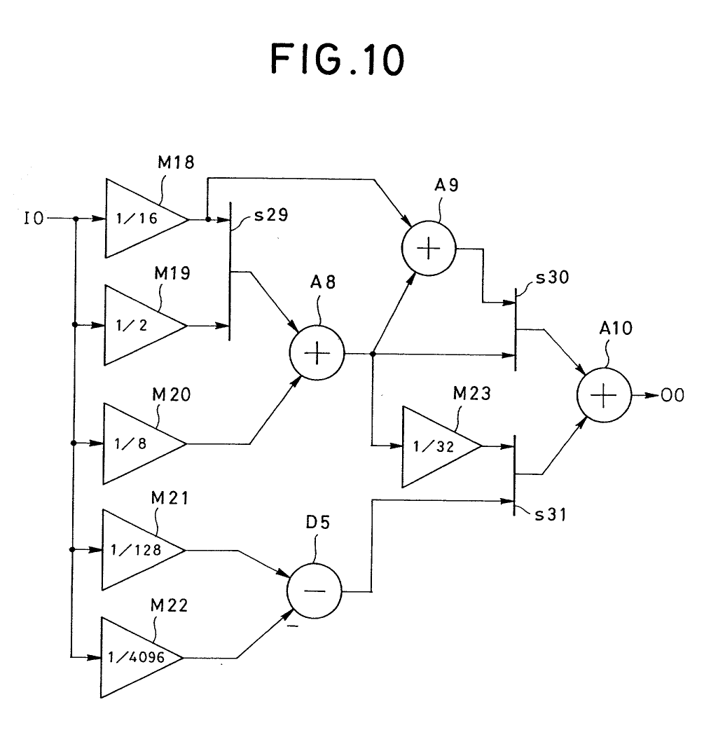

FIG. 10 is a block diagram showing an example of a construction of a dual mode selective computing unit T4 of FIG. 9. In FIG. 10, the dual mode selective computing unit T4 is constructed with the adders A8 to A10, the subtracter D5, the multipliers M18 to M22 and the selectors s29 to s31. The operation is similar to operation of the dual mode selective computing units T1 to T3.

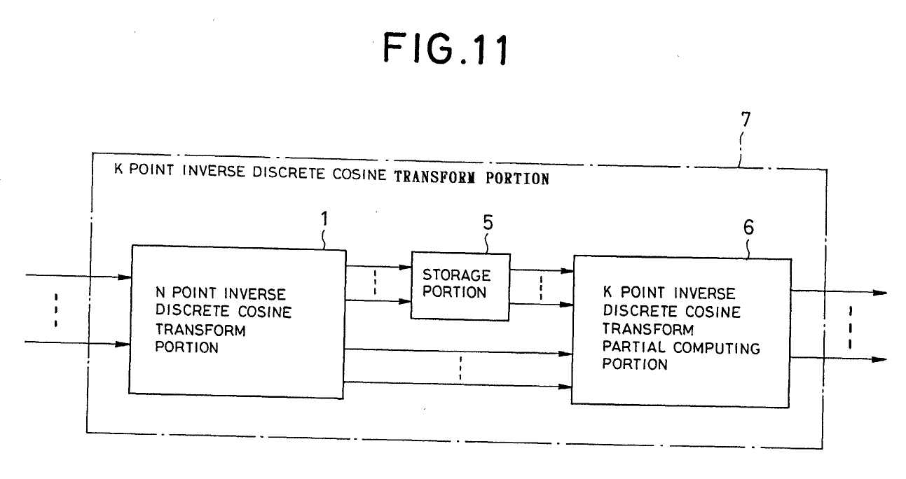

FIG. 11 is a block diagram showing a construction of the fourth embodiment of the inverse discrete cosine transform system according to the present invention. In the first to third embodiments of the N point inverse discrete cosine transform of the present invention, inverse discrete cosine transform smaller than N point is performed. In contrast to this, in FIG. 11, the fourth embodiment of the inverse discrete cosine transform according to the present invention, the N point inverse discrete cosine transform portion 1 operates as the M mode selective computing unit for realizing inverse discrete cosine transform for K points greater than N points. Hereinafter, discussion will be given with assumption that K is K>N and powers of 2.

Hereinafter, discussion will be given for only computing mode for performing K point inverse discrete cosine transform. A K point inverse discrete cosine transform portion 7 performing K point inverse discrete cosine transform is constructed with the N point inverse discrete cosine transform portion 1, the storage portion 5 and the K point inverse discrete cosine transform partial computing portion 6.

In the N point inverse discrete cosine transform portion 1, if the computing mode is K point inverse discrete cosine transform, the computing function is at first switched to N point inverse discrete cosine transform to perform N point inverse discrete cosine transform and the result of computing is supplied to the storage portion 5.

Next, the N point inverse discrete cosine transform 1 switches the computing function to K point inverse discrete cosine transform partial computing to perform K point inverse discrete cosine transform partial computation to supply the result of computation to the K point inverse discrete cosine transform partial computing portion 6.

In the K point inverse discrete cosine transform partial computing portion 6, using the result of computation supplied from the N point inverse discrete cosine transform portion 1 and the storage portion 5, K point inverse discrete cosine transform partial computing is performed to output the result of computation of K point inverse discrete cosine transform.

In the shown embodiment, since the K point inverse discrete cosine transform greater than N points is realized by the N point inverse discrete cosine transform 1, the storage portion 5 and the K point inverse discrete cosine transform partial computing portion 6. Therefore, in comparison with the case where the K point inverse discrete cosine transform is realized by the first embodiment, the construction of the N point inverse discrete cosine transform portion 1 does not become complicate. However, delay of computation can be increased.

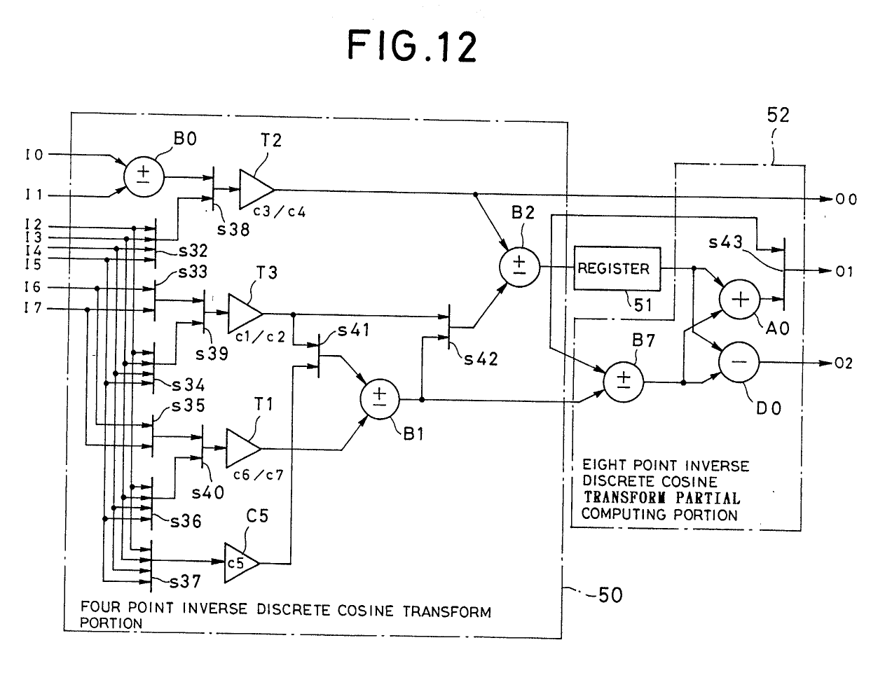

FIG. 12 is a block diagram showing a construction of the fourth embodiment of the four point inverse discrete cosine transform system according to the present invention. In FIG. 12, the fourth embodiment of the four point inverse discrete cosine transform system according to the present invention has three computing modes to perform four point inverse discrete cosine transform in the first computing mode, two point inverse discrete cosine transform in the second computing mode, and eight point inverse discrete cosine transform in the third computing mode.

In the fourth embodiment of the present invention, the four point inverse discrete cosine transform is constructed with a four point inverse discrete cosine transform portion 50, a register 51, and a eight point inverse discrete cosine transform partial computing portion 52.

The four point inverse discrete cosine transform 50 is constructed with adder-subtracters B0 to B2, a multiplier C5, the dual mode selective computing units T1 to T3 and selectors s32 to s42. The eight point inverse discrete cosine transform partial computing portion 52 is constructed with the adder A0, the adder-subtracter B7, the subtracter D0 and the selector s43.

In the shown embodiment, in the first and second computing modes, operation similar to the first embodiment is performed to realize the four point inverse discrete cosine transform and the two point inverse discrete cosine transform.

In the third computing mode, at first, in order to perform matrix operation in the determinant (7), the multipliers of the dual mode selective computing units T1, T2 and T3 are switched to c4, c2 and c6. The four point inverse discrete cosine transform portion 50 performs four point inverse discrete cosine transform to supply the result of computation to the register 51.

Next, after four point inverse discrete cosine transform, multipliers of the dual mode selective computing units T1, T2 and T3 are switched to c3, c1 and c7 to perform matrix operation in the determinant (8) in the four point inverse discrete cosine transform portion 50 to supply the result of computation to the eight point inverse discrete cosine transform partial computing portion 52.

In the eight point inverse discrete cosine transform partial computing portion 52, the result of computation supplied from the register 51 and the result of computation supplied from the four point inverse discrete cosine transform portion 50 are used to perform butterfly operation to output the result of computation of the eight point inverse discrete cosine transform to the output terminals O1 and O2.

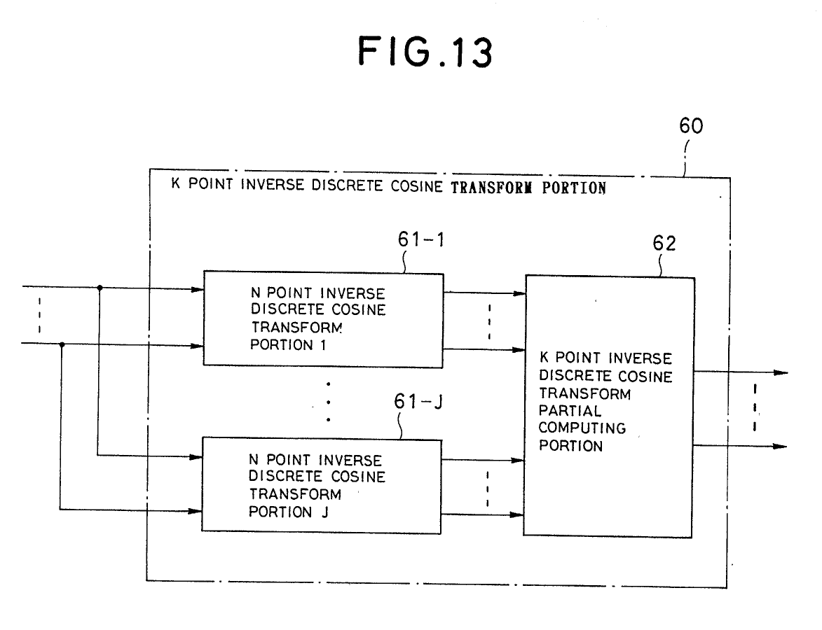

FIG. 13 is a block diagram showing a construction of the fifth embodiment of the inverse discrete cosine transform system according to the present invention. In the foregoing fourth embodiment of the inverse discrete cosine transform system set forth above, the computing mode of the N point inverse discrete cosine transform portion 1 is switched in time division to perform the inverse discrete cosine transform for K points greatert than N points. In contrast to this, in FIG. 13, the fifth embodiment of the inverse discrete cosine transform system according to the present invention, K point inverse discrete cosine transform is realized by arranging N point inverse discrete cosine transform portions 1 in parallel.

Hereinafter, discussion will be given only for computing mode performing K point inverse discrete cosine transform. The K point inverse discrete cosine transform portion 60 performing K point inverse discrete cosine transform is constructed with J in number of N point inverse discrete cosine transform portions [(1) to (J)] 61-1 to 61-J, and K point inverse discrete cosine transform partial computing portion 62.

In the N point inverse discrete cosine transform portions 61-1 to 61-J, when the computing mode is K point inverse discrete cosine transform, the computing function is switched into the K point inverse discrete cosine transform partial computation to perform K point inverse discrete cosine transform partial computation to supply the result of computation to the K point inverse discrete cosine transform partial computing portion 62.

In the K point inverse discrete cosine transform partial computing portion 62, using the result of computation supplied from the N point inverse discrete cosine transform portion 61-1 to 61-J, K point inverse discrete cosine transform partial computation is performed to output the result of computation of the K point inverse discrete cosine transform.

Since the shown embodiment takes a construction, in which a plurality of N point inverse discrete cosine transform portions 1 are arranged, N point inverse discrete cosine transform process can be performed at high speed. On the other hand, the K point inverse discrete cosine transform portion 60 is constructed by using the computing units of a plurality of N point inverse discrete cosine transform portions 61-1 to 61-J to restrict increasing of number of computing unit required for K point inverse discrete cosine transform partial computation.

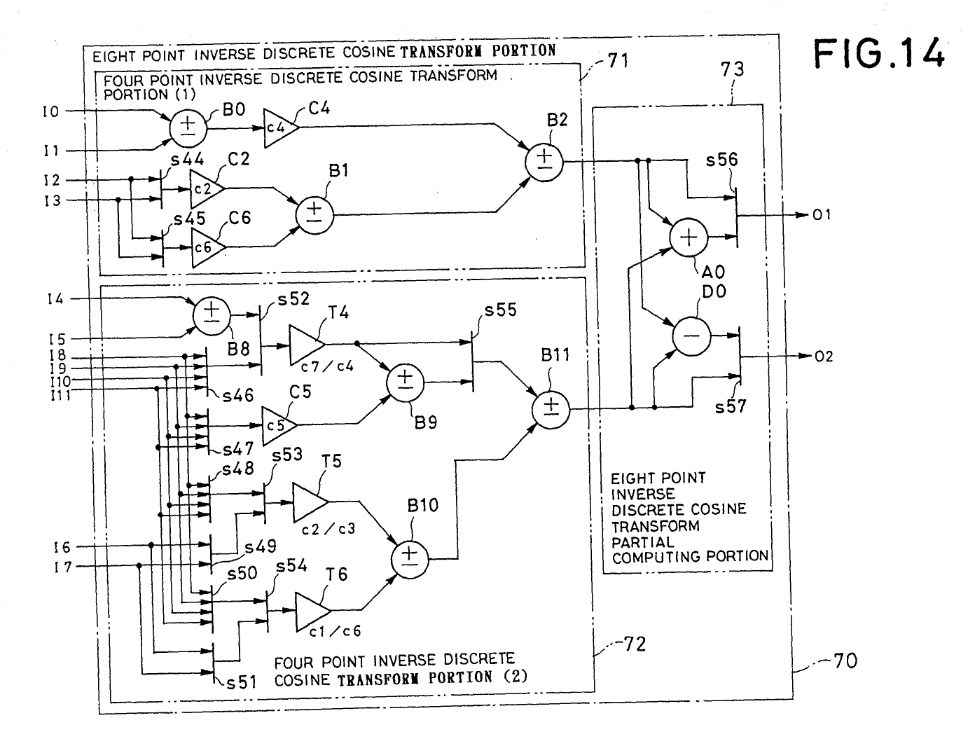

FIG. 14 is a block diagram showing a construction of the fifth embodiment of the inverse discrete cosine transform system according to the present invention. In FIG. 14, the fifth embodiment of the eight point inverse discrete cosine transform portion 70 which performs the eight point inverse discrete cosine transform is constructed with a four point inverse discrete cosine transform portion (1) 71, a four point inverse discrete cosine transform portion (2) 72 and an eight point inverse discrete cosine transform partial computing portion 73.

The four point inverse discrete cosine transform portion (1) 71 is constructed with adder-subtracters B0 to B2, multipliers C2, C4 and C6 and selectors s44 and s45. The four point inverse discrete cosine transform portion (2) 72 is constructed with adder-subtracters B8 to B11, a multiplier C5, dual mode selective computing units T4 to T6, and selectors s46 to s55. Also, the eight point inverse discrete cosine transform partial computing portion 73 is constructed with an adder A0, a subtracter D0 and selectors s56 and s57.

The shown embodiment has three computing modes to perform four point inverse discrete cosine transform in a first computing mode, two point inverse discrete cosine transform in a second computing mode and eight point inverse discrete cosine transform in a third computing mode. In the first and second computing modes, the operation similar to those in the first embodiment is performed in parallel to realize four point inverse discrete cosine transform and two point inverse discrete cosine transform are realized. It should be noted that, in FIG. 14. the second computing mode is eliminated for the purpose of illustration.

Hereinafter, discussion will be given for the third computing mode. In the four point inverse discrete cosine transform portion 71, four point inverse discrete cosine transform is performed to supply the result of computation to the eight point inverse discrete cosine transform partial computing portion 73.

In the four point inverse discrete cosine transform portion 72, the multipliers of respective of the dual mode selective computing units T4, T6 and T7 are switched into c7, c3 and c1 to perform matrix operation in the foregoing determinant (8) to supply the result of computation to the eight point inverse discrete cosine transform partial computing portion 73.

In the eight point inverse discrete cosine transform partial computing portion 73, using the result of computation supplied from the four point inverse discrete cosine transform portion 71 and the result of computation supplied from the four point inverse discrete cosine transform portion 72, butterfly operation is performed to output the result of computation of eight point inverse discrete cosine transform to the output terminals O1 and 02.

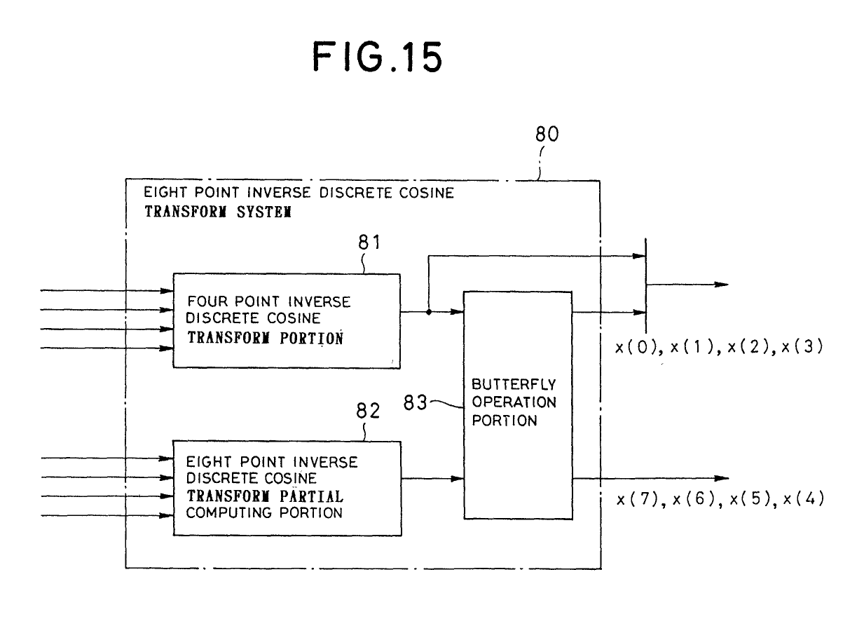

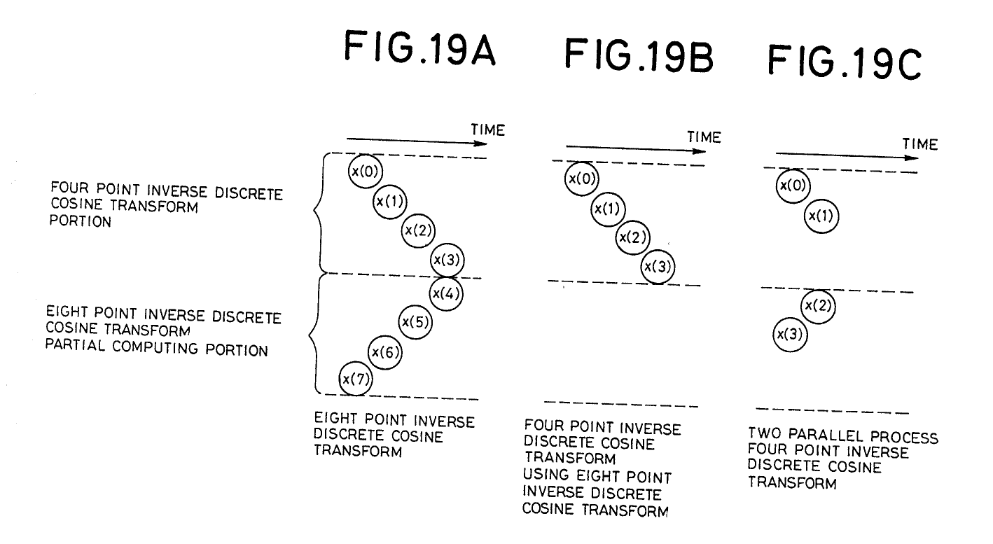

FIGS. 15 to 19 are illustration for explaining the effect of the present invention. The eight point inverse discrete cosine transform system 80 shown in Fig.15 receives the eight DCT coefficients X(0) to X(7) as inputs to output to every two original signals [x(0), x(7)], [x(1), x(6)], [x(2), x(5)] and [x(3), x(4)] in sequential order. As a result, for performing eight inverse discrete cosine transform, four times of computation is required. FIG. 19A shows output timings of the original signals.

Here, in the eight point inverse discrete cosine transform system 80 of FIG. 15, the butterfly operation is performed by the butterfly operation portion 83 at the end of the process. However, since computing for x(0) to x(3) is performed in four point inverse discrete cosine transform portion 81, computation for x(4) to x(7) is performed in the eight point inverse discrete cosine transform portion 82. Therefore, the drawing is illustrated as output per computing portions.

Consideration is given for four point inverse discrete cosine transform by the eight point inverse discrete cosine transform system 80 of FIG. 15. The four point inverse discrete cosine transform is included in the eight point inverse discrete cosine transform. Then, as the output of the four point inverse discrete cosine transform, the output of the four point inverse discrete cosine transform portion 81 is output directly. In this case, the output timing is as shown in FIG. 19B to every one outputs in order to x(0), x(1), x(2) and (3) in sequential order. As a result, when four point inverse discrete cosine transform is performed by using the eight point inverse discrete cosine transform system 80, the same number of times of computation as the eight point inverse discrete cosine transform is required.

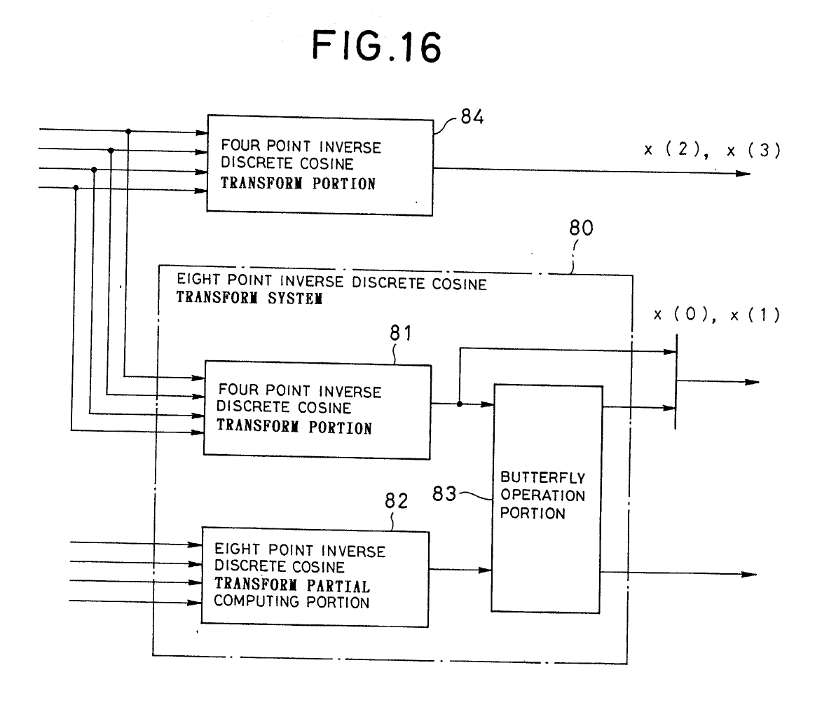

Next, consideration is given for the case where even in the four point inverse discrete cosine transform, similar to eight point inverse discrete cosine transform, every two original signals are output at every computation. As the simplest method to realize is to add a four point inverse discrete cosine transform portion 84 as shown in FIG. 16. However, in this case, the scale of the system is inherently increased.

In the eight point inverse discrete cosine transform system 80 according to the present invention, two computing functions of partial computing (computing mode 1) of the eight point inverse discrete cosine transform and four point inverse discrete cosine transform (computing mode 2) are provided for the eight point inverse discrete cosine transform partial computing portion 82.

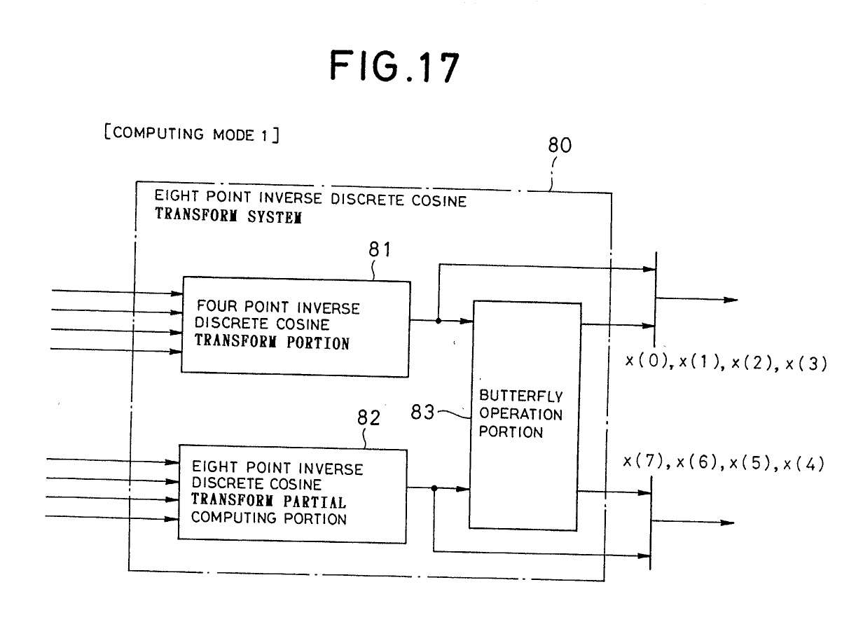

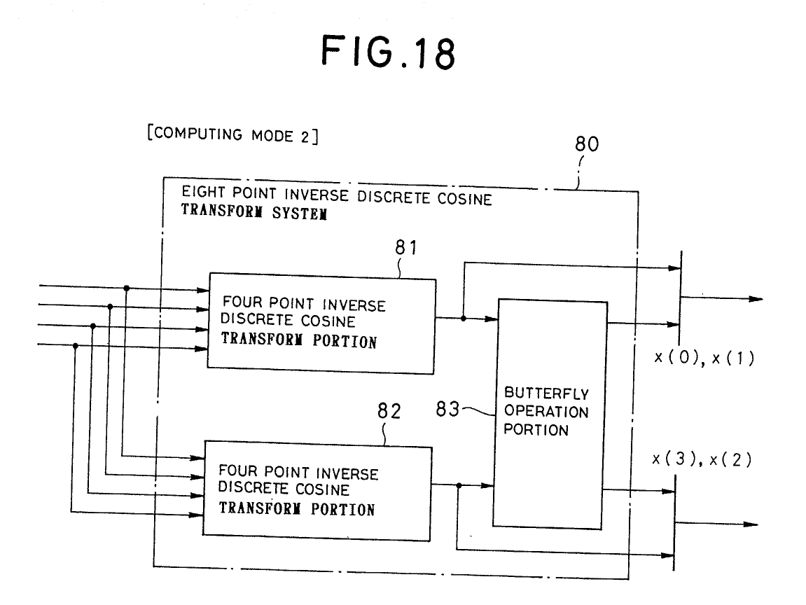

FIGS. 17 and 18 show functional construction for the cases two computing modes are employed. In the computing mode 1, the eight point inverse discrete cosine transform similar to FIG. 15 is performed as shown in FIG. 17.

In the computing mode 2, the computing function of the eight point inverse discrete cosine transform partial computing portion 82 is switched into the function of the four point inverse discrete cosine transform portion 81 to perform four portion inverse discrete cosine transform in parallel as shown in FIG. 18. Output timing in the computing mode 2 is shown in FIG. 19C.

As set forth above, in the shown embodiment, a plurality of computing functions are switched for realizing parallel operation to obtain the desired output with half of the typical processing period. On the other hand, since the computing unit of the eight point inverse discrete cosine transform partial computing portion 82 are used in common, which are not operated when four point inverse discrete cosine transform is performed in the four point inverse discrete cosine transform portion 81. Therefor, in comparison with the case where the four point inverse discrete cosine transform unit 82 is added, the system with simpler construction can be realized.

Accordingly, it becomes possible to realize the system which can perform discrete cosine transform and inverse discrete cosine transform for a plurality of different block sizes. Concerning processes for small block size, high speed process and simplification of system construction are realized by operating the computing units in parallel.

As set forth above, by enabling parallel operation of N/2ⁿ point discrete cosine transform with a plurality of computing, in case of the N/2ⁿ inverse discrete cosine transform, speeding up can be realized for permitting higher speed process than the conventional discrete cosine transform system.

On the other hand, in a plurality of computing function, since communization of the computing units are made common, increasing of the system scale by addition of the function of the computing units can be eliminated to realize higher processing speed than that in the states.

As set forth above, according to the present invention, in addition to the first computing modes, in addition thereto, in the discrete cosine transform system having one or more computing modes for performing either discrete cosine transform or inverse discrete cosine transform for W points which is smaller than N points, upon performing either discrete cosine transform or inverse discrete cosine transform in at least a part of computing modes, W point discrete cosine transform or W point inverse discrete cosine transform is performed in parallel, speeding up and restriction of increasing of system scale associating with speeding up can be achieved in the system realizing discrete cosine transform or inverse discrete cosine transform for a plurality of mutually different sizes of black.

Although the present invention has been illustrated and described with respect to exemplary embodiment thereof, it should be understood by those skilled in the art that the foregoing and various other changes, omission and additions may be made therein and thereto, without departing from the spirit and scope of the present invention. Therefore, the present invention should not be understood as limited to the specific embodiment set out above but to include all possible embodiments which can be embodied within a scope encompassed and equivalent thereof with respect to the feature set out in the appended claims.

What is claimed is:

1. A discrete cosine transform system having one ore more computing modes for performing one of discrete cosine transform and inverse discrete cosine transform for W points which W is positive integer satisfying N>W, in addition to a first computing mode for performing one of discrete cosine transform and inverse discrete cosine transform for N points which N is positive integer, comprising:
means provided at least a part of computing units forming said system, for switching computing function in at least part of computing functions for performing discrete cosine transform and inverse discrete cosine transform for points other than N points, for performing said W point discrete cosine transform and inverse discrete cosine transform in parallel by the computing units forming said system.

2. A discrete cosine transform system as set forth in claim 1, wherein N is powers of 2, and the W points is N/2ⁿ (n is a positive integer satisfying 2ⁿ≦N).

3. A discrete cosine transform system as set forth in claim 1, which further has computing modes for performing one of N point discrete cosine transform and N point inverse discrete cosine transform as partial computation of one of K point discrete cosine transform and K point inverse discrete cosine transform, which K point is greater than N point, and for performing partial computation of one of discrete cosine transform and inverse discrete cosine transform for other than N points, and said system comprises storage means for storing results of computation; and
computing means for performing partial computation of one of said K point discrete cosine transform and K point inverse discrete cosine transform using the result of computation and a storage value of said storage means.

4. A discrete cosine transform system as set forth in claim 3, wherein N points and K points are powers of 2.

5. A discrete cosine transform system as set forth in claim 1, which has a plurality of systems each having computing mode for performing one of N point discrete cosine transform and N point inverse discrete cosine transform, computing modes for performing one of W point discrete cosine transform and W point inverse discrete cosine transform, which W is smaller than N, and computing mode for performing partial computation of one of K point discrete cosine transform and K point inverse discrete cosine transform which K is greater than N, said systems are adapted for parallel operation, and said discrete cosine transform system includes computing means for performing partial computation one of K point discrete cosine transform and K point inverse discrete cosine transform.

6. A discrete cosine transform system as set forth in claim 5, wherein said N points and K points are powers of 2 and W points is N/2ⁿ (n is a positive integer satisfying 2ⁿ≦N).

7. A discrete cosine transform method having one ore more computing modes for performing one of discrete cosine transform and inverse discrete cosine transform for W points which W is positive integer satisfying N>W, in addition to a first computing mode for performing one of discrete cosine transform and inverse discrete cosine transform for N points which N is positive integer, comprising:
switching computing function in at least part of computing functions for performing discrete cosine transform and inverse discrete cosine transform for points other than N points, for performing said W point discrete cosine transform and inverse discrete cosine transform in parallel by the computing units forming said system.

8. A discrete cosine transform method as set forth in claim 7, wherein N is powers of 2, and the W points is N/2ⁿ (n is a positive integer satisfying 2ⁿ≦N).

9. A discrete cosine transform method as set forth in claim 7, which further has computing modes for performing one of N point discrete cosine transform and N point inverse discrete cosine transform as partial computation of one of K point discrete cosine transform and K point inverse discrete cosine transform, which K point is greater than N point, and for performing partial computation of one of discrete cosine transform and inverse discrete cosine transform for other than N points, and
comprising steps of
storing results of computation; and
performing partial computation of one of said K point discrete cosine transform and K point inverse discrete cosine transform using the result of computation and a storage value of said storage means.

10. A discrete cosine transform method as set forth in claim 9, wherein N points and K points are powers of 2.

11. A discrete cosine transform method as set forth in claim 7, which performs computing mode for performing one of N point discrete cosine transform and N point inverse discrete cosine transform, computing modes for performing one of W point discrete cosine transform and W point inverse discrete cosine transform, which W is smaller than N, and computing mode for performing partial computation of one of K point discrete cosine transform and K point inverse discrete cosine transform which K is greater than N in parallel operation, and said discrete cosine transform system includes computing means for performing partial computation one of K point discrete cosine transform and K point inverse discrete cosine transform.

12. A discrete cosine transform method as set forth in claim 11, wherein said N points and K points are powers of 2 and W points is N/2ⁿ (n is a positive integer satisfying 2ⁿ≦N).

13. A discrete cosine transform system comprising:
input selecting portion determining a destination for supplying input DCT coefficient;
N/2ⁿ point inverse discrete cosine transform performing N/2ⁿ point inverse discrete cosine transform for DCT coefficients input from said input selecting portion;
dual mode selective computing portion performing partial computation of N point inverse discrete cosine transform or N/2ⁿ point inverse discrete cosine transform for DCT coefficients input from said input selecting portion; and
N point inverse discrete cosine transform partial computing portion for performing partial computation of N point inverse discrete cosine transform or multiplication of coefficients from the result of computation supplied from said N/2ⁿ point inverse discrete cosine transform portion and the result of computation supplied from said dual mode selective computing portion.

14. A discrete cosine transform system as set forth in claim 13, wherein said dual mode selective computing portion is replaced with M mode selective computing portion for selection among three or more modes.

15. A discrete cosine transform system as set forth in claim 14, wherein a plurality of said M mode selective computing circuit for parallel operation is included.

16. A discrete cosine transform system comprising:
N point inverse discrete cosine transform portion performing either N point inverse discrete cosine transform or partial computation of K (K>N) point inverse discrete cosine transform;
storage portion storing result of computation of N point inverse discrete cosine transform in said N point inverse discrete cosine transform portion; and
K point inverse discrete cosine transform partial computing portion performing partial computation of K point inverse discrete cosine transform using the result of computation supplied from said storage portion and a result of computation of K point inverse discrete cosine transform partial computation supplied from said N point inverse discrete cosine transform portion.

17. A discrete cosine transform system comprising:
a plurality of N point inverse discrete cosine transform portions operable in parallel and performing computation by switching computing function to partial computation of K point (K>N) inverse discrete cosine transform;
K point inverse discrete cosine transform partial computing of K point inverse discrete cosine transform using the result of partial computation of K point inverse discrete cosine transform supplied from said plurality of N point inverse discrete cosine transform portions.
